(19) United States
(12) Patent Application Publication
(10) Pub. No.: US 2019/0158180 A1
(43) Pub. Date: May 23, 2019

(54) WIFI NETWORKING METHOD AND SYSTEM VIA INFRARED TRANSMISSION

(71) Applicant: SHENZHEN SKYWORTH-RGB ELECTRONIC CO, LTD, Shenzhen (CN)

(72) Inventor: Kunpeng WANG, Shenzhen (CN)

(73) Assignee: SHENZHEN SKYWORTH RGB ELECTRONIC CO, LTD, Shenzhen (CN)

(21) Appl. No.: 15/571,422

(22) PCT Filed: Sep. 15, 2015
(86) PCT No.: PCT/CN2015/089582

§ 371 Date: Nov. 2, 2017

(30) Foreign Application Priority Data
May 25, 2015 (CN) 201510269609.3

(51) Int. Cl. H04B 10/114; H04L 29/06; H04W 76/10; H04W 52/02

(52) U.S. Cl. CPC H04B 10/1149; H04B 10/1143; H04L 63/083; H04W 84/12; H04W 76/10; H04W 52/0203; H04L 63/102

(57) ABSTRACT

Disclosed are a WIFI networking method and system via infrared transmission. The WIFI networking method comprises: in a WIFI networking mode, a terminal acquires networking information about a router and converts same into an infrared signal and transmits the infrared signal to an electrical appliance; the electrical appliance receives and parses the infrared signal to obtain the networking information, and initiates a connection request to the router according to the networking information; and the electrical appliance establishes a WIFI connection to the router in response to the connection information about the router. By means of transmission in an infrared manner, even in a complicated WIFI environment, a quick and stable WIFI connection can be realized without the electrical appliance monitoring all the time, thereby reducing the power consumption. The present invention also makes use of the existing infrared transceiving modules in the terminal and the electrical appliance, thereby saving costs.

### CROSS-REFERENCES TO RELATED APPLICATIONS

This application is a national stage application of PCT Patent Application No. PCT/CN2015/089582, filed on Sep. 15, 2015, which claims priority to Chinese Patent Application No. 201510269609.3, filed on May 25, 2015, the content of all of which is incorporated herein by reference.

### FIELD OF THE INVENTION

The present invention relates to the field of electronic products technology, and more particularly, to a WIFI networking method and system via infrared transmission.

### BACKGROUND

With a popularization of Internet of Things, more and more electrical appliances have a feature of WIFI networking, such as an intelligent air conditioning (AC). However, most of these electrical appliances have no display interface or input module, they may make a WIFI connection through inputting configuration information by a phone or a remoter only. Such an operation is very troublesome, although some WIFI modules in some electrical appliances support a function of one-click-configuration by software installed in a mobile phone, the function is very unstable, especially in an environment with a pretty complex network situation, it is very hard to configure successfully, instead, it increases a complexity of the electrical appliance networking. It becomes a key difficulty how to make the electrical appliances connect to the Internet quickly and steadily.

Currently, a common method often used for a WIFI networking of the electrical appliance is a one-click-configuration. The WIFI module in the electrical appliance has been configured to be a WIFI monitoring mode, when the WIFI module is making a factory value setting. A user only needs to input into a smart phone an account ID and a password about a wireless router, followed by clicking a button before achieving the one-click-configuration. After clicking the button, the smart phone sends routing information to air (like broadcasts the routing information). The routing information includes an SSID (Service Set Identifier, an ID of the wireless router), an encryption type, an encryption key, and so on. Since the WIFI module of the electrical appliance is in a WIFI monitoring mode, the WIFI module may monitor all WIFI communications in a preset range (smaller) of a space, that is, monitor all WIFI data transmitting in the environment. The WIFI module then parses the routing information including a current working channel, the encryption type of the wireless router and else, according to a frame of the WIFI data being monitored, followed by saving the routing information and making a WIFI connection with the wireless router. Now the user may achieve a function of the one-click-configuration after inputting the account ID and the password, together with clicking the button, wherein, a plurality of parameters of the wireless router is obtained by negotiating between the software of one-click-configuration and the WIFI module, which greatly reduces a configuration process of the user, and the user does not need any professional terms to make the configuration.

Although the existing one-click-configuration has a simple operation, comparing to a traditional soft AP configuration method, it requires a longer configuration time, and sometimes it may reach up to 30 seconds or even more. Also, the existing one-click-configuration may appear a situation of configuration failure, since the WIFI module is working in the WIFI monitoring mode, if there is too much WIFI data transmitting in the current space, interference may be pretty large, and the networking may fail.

Therefore, the current technology needs to be improved and developed.

### BRIEF SUMMARY OF THE DISCLOSURE

According to the above described defects, the purpose of the present invention is providing a WIFI networking method and system via infrared transmission, in order to reduce a cost, and be capable of a fast and stable networking.

In order to achieve the above mentioned goals, the technical solution of the present invention to solve the technical problems is as follows:

A WIFI networking method via infrared transmission, wherein, it comprises a plurality of steps:
in a WIFI networking mode, a terminal acquires a networking information about a router and converts same into an infrared signal and transmits the infrared signal to an electrical appliance;
the electrical appliance receives and parses the infrared signal to obtain the networking information, and initiates a connection request to the router according to the networking information; and
the electrical appliance establishes a WIFI connection to the router in response to the connection information about the router.

The WIFI networking method via infrared transmission, wherein, before the step of the terminal acquiring the networking information about the router and converting same into the infrared signal and transmitting the infrared signal to the electrical appliance, it further includes:
the terminal pre-installs a networking software;
when connecting to the router, the terminal searches automatically for and obtains wireless information about the router, before establishing a WIFI connection with the router according to an input WIFI password about the router;
the terminal enters a WIFI networking mode after the networking software being started.

The WIFI networking method via infrared transmission, wherein, the step of the terminal acquiring a networking information about the router and converting same into the infrared signal and transmitting the infrared signal to the electrical appliance in a WIFI networking mode, includes specifically:
the terminal acquires the networking information about the router in the WIFI networking mode, the networking information comprises a WIFI account ID and a password about the router;
generates an infrared code value through infrared encoding the WIFI account ID and the password;
superimposes the infrared code value and a carrier signal and generates an infrared signal before transmitting to the electrical appliance.

The WIFI networking method via infrared transmission, wherein, the step of generating an infrared code value through infrared encoding the WIFI account ID and the password includes specifically:
converting each character in the WIFI account ID and the password into an ASCII code value;
converting the ASCII code value into a binary number accordingly, and obtaining a data code composed by 0 and 1;
adding a head code, a user code and an end code into the data code, before obtaining the infrared code value.

The WIFI networking method via infrared transmission, wherein, the step of the electrical appliance receiving and parsing the infrared signal to obtain the networking information, and initiating a connection request to the router according to the networking information includes specifically:
the electrical appliance receives the infrared signal before parsing the same, identifies an instruction type of the user code;
extracts the WIFI account ID and the password from the data code, when identifying the user code to be an instruction of transmitting the networking information;
initiates a connection request to the router according to the WIFI account ID and the password obtained.

The WIFI networking method via infrared transmission, wherein, after the step of the electrical appliance establishing a WIFI connection to the router in response to the connection information about the router, it further includes:
the electrical appliance feeds a WIFI connection status between the electrical appliance and the router back to the terminal.

A WIFI networking system via infrared transmission, wherein, it includes the terminal and the electrical appliance;
the terminal acquires a networking information about a router and converts same into an infrared signal and transmits the infrared signal to the electrical appliance, in a WIFI networking mode; the electrical appliance parses the infrared signal to obtain the networking information, and initiates a connection request to the router according to the networking information; and the electrical appliance establishes a WIFI connection to the router in response to the connection information about the router.

The WIFI networking system via infrared transmission, wherein, the terminal comprises:
a first WIFI module, applied to searching automatically for and obtaining the wireless information about the router, before establishing the WIFI connection with the router according to the input WIFI password about the router , when connecting to the router;
a networking module, applied to entering the WIFI networking mode, obtaining the networking information about the router, the networking information comprises the WIFI account ID and the password about the router; and generating the infrared code value through infrared encoding the WIFI account ID and the password;
a first infrared transceiving module, applied to superimposing the infrared code value and the carrier signal and generating an infrared signal before transmitting to the electrical appliance.

The WIFI networking method via infrared transmission, wherein, the electrical appliance comprises:
a second infrared transceiving module, applied to receiving the infrared signal and transmitting the same;
an infrared encoding and decoding device, applied to parsing the infrared signal, identifying the instruction type of the user code; and outputting the infrared code value after being decoded, when identifying the user code to be an instruction of transmitting the networking information;
a second WIFI module, applied to extracting the WIFI account ID and the password from the infrared code value; and initiating a connection request to the router according to the WIFI account ID and the password obtained.

The WIFI networking system via infrared transmission, wherein, the electrical appliance is further applied to feeding the WIFI connection status between the electrical appliance and the router back to the terminal.

The present invention provides a WIFI networking method and system via infrared transmission. In a WIFI networking mode, a terminal acquires a networking information about a router and converts same into an infrared signal and transmits the infrared signal to an electrical appliance; the electrical appliance parses the infrared signal to obtain the networking information, and initiates a connection request to the router according to the networking information; and the electrical appliance establishes a WIFI connection to the router in response to the connection information about the router. By means of transmission in an infrared manner, even in a complicated WIFI environment, a quick and stable WIFI connection can be realized without the electrical appliance monitoring all the time, thereby reducing power consumption. The present invention also makes use of the existing infrared transceiving modules in the terminal and the electrical appliance, thereby saving costs.

### BRIEF DESCRIPTION OF THE DRAWINGS

FIG. 1 illustrates a flow chart on a preferred embodiment of the WIFI networking method via infrared transmission as provided in the present invention;

FIG. 2 illustrates a specific flow chart on a preferred embodiment before a step S100 in the WIFI networking method via infrared transmission as provided in the present invention;

FIG. 3 illustrates a specific flow chart on a preferred embodiment of the step S100 in the WIFI networking method via infrared transmission as provided in the present invention;

FIG. 4 illustrates a specific flow chart on a preferred embodiment of a step S102 in the WIFI networking method via infrared transmission as provided in the present invention;

FIG. 5 illustrates a schematic diagram of infrared encoding in the WIFI networking method via infrared transmission as provided in the present invention;

FIG. 6 illustrates a schematic diagram of an infrared code value in the WIFI networking method via infrared transmission as provided in the present invention;

FIG. 7 illustrates a specific flow chart of a preferred embodiment on the step S200 in the WIFI networking method via infrared transmission as provided in the present invention;

FIG. 8 illustrates a functional block diagram on an embodiment of the WIFI networking system via infrared transmission as provided in the present invention;

FIG. 9 illustrates a functional block diagram on an inside of a terminal of an embodiment of the WIFI networking system via infrared transmission as provided in the present invention;

FIG. 10 illustrates a functional block diagram on an inside of an electrical appliance of an embodiment of the WIFI networking system via infrared transmission as provided in the present invention

### DETAILED DESCRIPTION OF EMBODIMENTS

The present invention provides a WIFI networking method and system via infrared transmission; it is only needed to install a networking software in a smart phone, followed by inputting an account ID and a password about a router, a WIFI module in an electrical appliance may be WIFI connected with a router having already connected to the smart phone. The smart phone converts the account ID and the password about the router into an infrared signal before transmitting to the electrical appliance one by one, thus even in a complex WIFI circumstance, it is able to achieve a fast and stable WIFI connection, which may be controlled in 5 seconds, with a good stability. By using a current infrared transceiving module in the smart phone and an infrared transceiving module in the electrical appliance (which is controlled by an infrared controller), and a parsing of the infrared signal may be achieved by adopting a main control unit in the WIFI module, thus, there is no extra hardware cost, the cost is saved. And even there is no infrared transceiving module in the electrical appliance and an additional addition is required, the cost needed is still low.

In order to make the purpose, technical solution and the advantages of the present invention clearer and more explicit, further detailed descriptions of the present invention are stated here, referencing to the attached drawings and some preferred embodiments of the present invention. It should be understood that the detailed embodiments of the invention described here are used to explain the present invention only, instead of limiting the present invention.

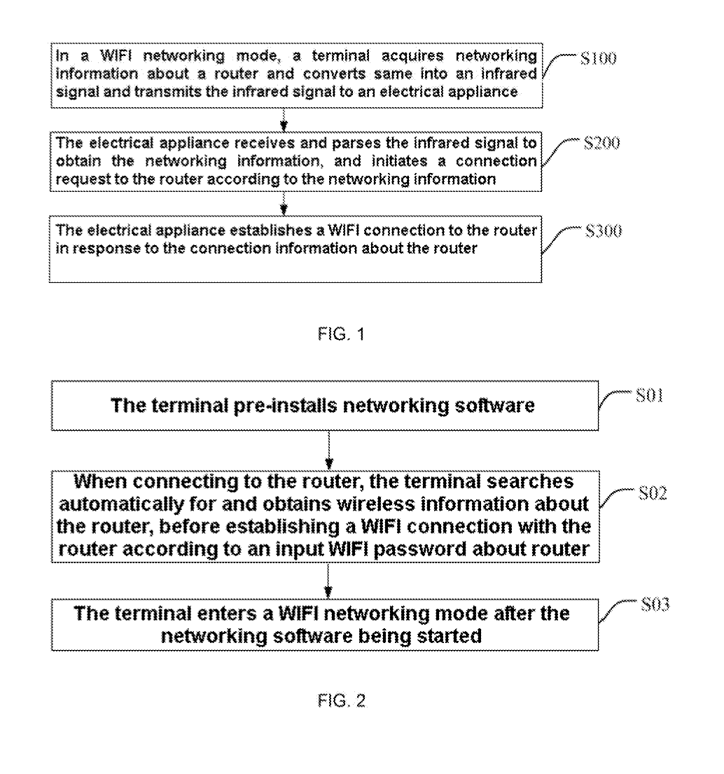

Referencing to FIG. 1, which is a flow chart on a preferred embodiment of the WIFI networking method via infrared transmission as provided in the present invention. Shown as FIG. 1, the WIFI networking method via infrared transmission includes a plurality of following steps:

S100. In a WIFI networking mode, a terminal acquires a networking information about a router and converts same into an infrared signal and transmits the infrared signal to an electrical appliance

S200. The electrical appliance receives and parses the infrared signal to obtain the networking information, and initiates a connection request to the router according to the networking information.

S300. The electrical appliance establishes a WIFI connection to the router in response to the connection information about the router.

Referencing to FIG. 2 together, in the present embodiment, before the step S100, it further includes:

S01. The terminal pre-installs a networking software;

S02. When connecting to the router, the terminal searches automatically for and obtains wireless information about the router, before establishing a WIFI connection with the router according to an input WIFI password about the router;

The terminal is preferably a smart phone, having a first WIFI module arranged inside thereof, which may query a plurality of WIFI hotspots around automatically. In the present embodiment, the WIFI hotspot is a wireless router. When a user needs to connect to the router, the first WIFI module searches automatically for and obtains wireless information about the router. The wireless information comprises an ID of the router, an encryption state, signal strength and more. The user chooses to connect to the specific router, and inputs the WIFI password of the router in a pop-up dialog box, before a WIFI connection between the terminal and the router is established.

S03. The terminal enters a WIFI networking mode after the networking software being started.

If the user needs to achieve a WIFI connection to the electrical appliance, he may then start and run the networking software before entering the WIFI networking mode. If it is not needed to control the electrical appliance to make the WIFI connection, then the networking software will not be started and the terminal will make a networking operation normally.

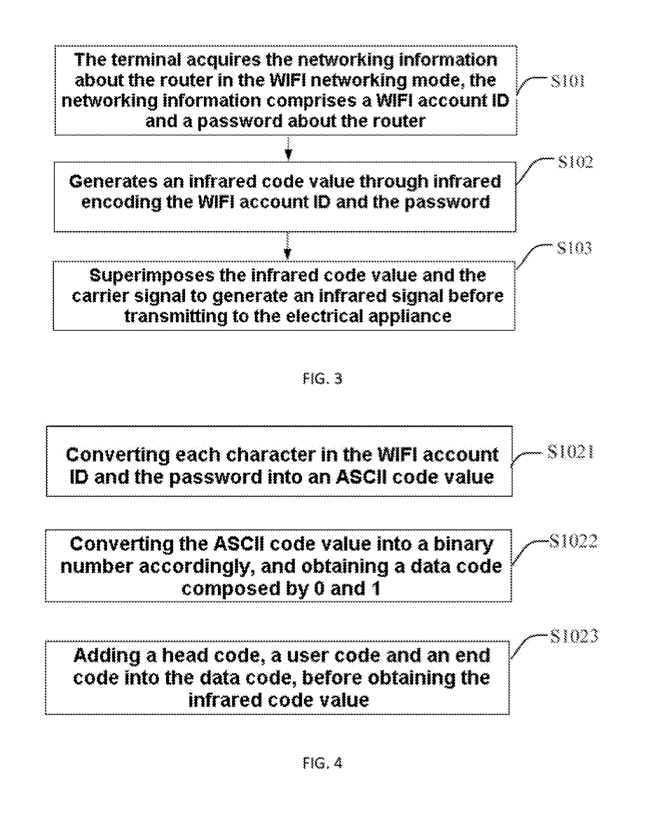

After entering the WIFI networking mode, it will start infrared encoding. Referencing to FIG. 3 together, the step S100 includes specifically:

S101. The terminal acquires the networking information about the router in the WIFI networking mode, the networking information comprises a WIFI account ID and a password of the router;

After entering the WIFI networking mode, the networking modules according to the networking software will first obtain the networking information about the router, the networking information comprises a WIFI account ID and a password of the router.

S102. Generates an infrared code value through infrared encoding the WIFI account ID and the password;

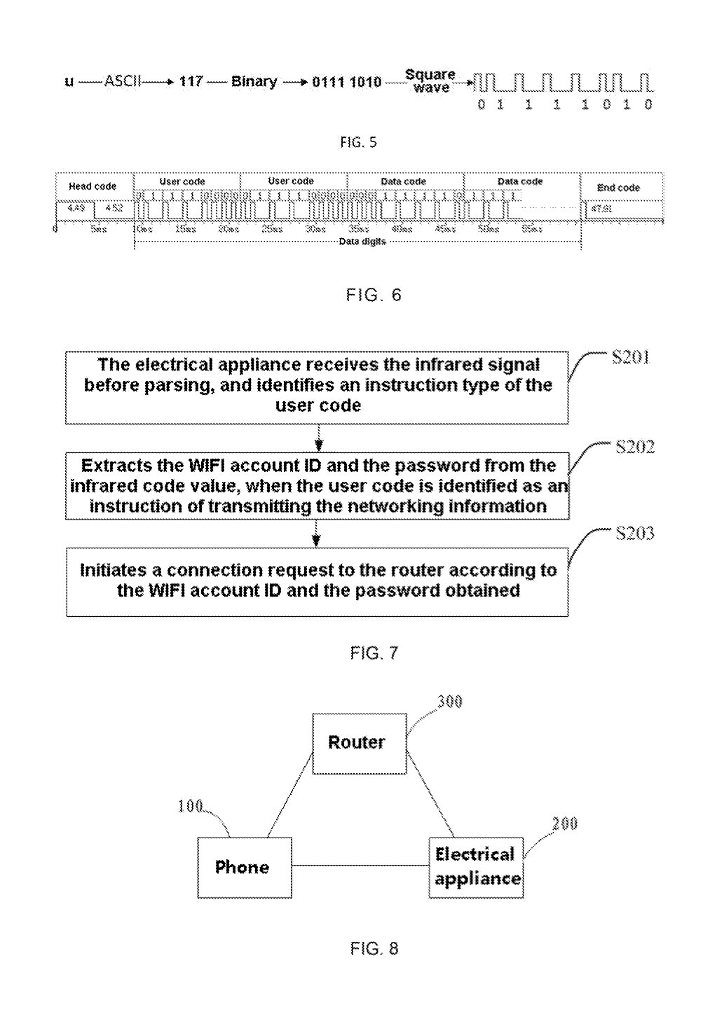

The networking module generates an infrared code value through infrared encoding the WIFI account ID and the password. Referencing to FIG. 4 and FIG. 5 together, since an existing embedded processing capacity is limited and a Chinese character font is relatively large, thus temporarily, the WIFI account ID and the password can not contain any Chinese characters. Therefore, in the present embodiment, an ASCII code conversion will be needed when making infrared encoding, which includes specifically:

S1021, converting each character in the WIFI account ID and the password into an ASCII code value;

S1022, converting the ASCII code value into a binary number accordingly, and obtaining a data code composed by 0 and 1;

S1023, adding a head code, a user code and an end code into the data code, before obtaining the infrared code value.

As shown in FIG. 5, suppose a WIFI account ID is uyz, which contains three characters; and a password is 079966, which contains 6 characters. According to an encoding role of the ASCII codes, an English character or a number character may be represented by an 8-digit binary number. Thus, the character “u” in the account ID accords to an ASCII code value of 117, which is 0111 1010 after being converted into a binary number, and a square wave consisting 0 and 1 is obtained. The 0 and 1 in binary is represented by a certain combination of high and low electrical levels, wherein, 0 in binary is composed by a high electrical level and a low electrical level with a length of 0.5 ms respectively, while 1 in binary is composed by a high electrical level with a length of 0.5 ms and a low electrical level with a length of 1.5 ms. A binary waveform according to “u” is shown in FIG. 5.

A series of square waves are obtained after converting all the characters in the account ID and the password according to the above described method, the square wave represents a data code of the account ID and the password.

Finally, adding the head code and the user code in front of the data code in a sequence, and adding the end code at the end of the data code. Referencing to FIG. 6 together, the head code is applied to representing a start position of the infrared code value, which is composed by a plurality of fixed high and low electrical levels. The user code is applied to representing an instruction type of the infrared code value, such as if it is a networking information or a general infrared remote instruction being transmitted, the user code is composed by a plurality of fixed binary numbers. In the present embodiment, the user code is set as a preset code value to represent that it is the networking information in zo transmission, such as 01110000(0E) 01110000(0E) shown in FIG. 6, represents that the infrared code value is transmitting the networking information.

The data code is followed by the end code, the end code is applied to representing a whole infrared code value ending, which is also composed by a plurality of fixed high and low electrical levels. It can be seen that, a whole infrared code value is composed by three periods, the head code, a plurality of data digits and the end code, the plurality of data digits comprises the user code and the data code.

It should be understood that, since the user code has defined a preset code value different to that in the existing technology, both the first infrared transceiving module of the terminal and the second infrared transceiving module of the electrical appliance need an encoding and decoding protocol, so the second infrared transceiving module may identify the instruction type of the user code before forwarding to a unit module accordingly, to avoid that an existing protocol may not be able to identify the user code thus discarding or not executing it.

S103. Superimposes the infrared code value and a carrier signal to generate an infrared signal before transmitting to the electrical appliance.

The first infrared transceiving module of the terminal superimposes the infrared code value and the carrier signal, before transmitting the generated infrared signal out in an infrared wave.

Referencing to FIG. 7 together, the step S200 comprises specifically:

S201. The electrical appliance receives the infrared signal before parsing, and identifies an instruction type of the user code;

The second infrared transceiving module arranged in the electrical appliance receives the infrared signal and transmits to the infrared encoding and decoding device. The infrared encoding and decoding device parses the infrared signal and obtains the infrared code value, identifies the head code and the user code.

S202. Extracts the WIFI account ID and the password from the infrared code value, when the user code is identified as an instruction of transmitting the networking information;

S203. Initiates a connection request to the router according to the WIFI account ID and the password obtained.

If the user code is identified as a control instruction sent directly to the electrical appliances, such as an instruction code of switching, adjusting size, and so on, then transmits directly the data code to a control unit of the electrical appliance, and the electrical appliance makes response to the data code directly. If the user code is identified as an instruction of transmitting the networking information, then transmits the infrared code value after decoding directly to the second WIFI module. The second WIFI module parses and extracts the WIFI account ID and the password from the data code of the infrared code value by itself, followed by transmitting the connection request to the router according to the WIFI account ID and password obtained. Once a response from the router is received, the electrical appliance will be added to the router automatically, and a WIFI connection between the electrical appliance and the router is achieved.

In the embodiments described above, a user's operation is that he only needs to input the WIFI password of the router and start the networking software at the terminal, while all other steps are executed automatically between the terminal, the electrical appliance and the router. In a specific embodiment, when the terminal transmits the infrared signal to the electrical appliance, it is possible to adopt a plurality of methods including flashing (a red light blinking) or voicing (beeping or ticking) to remind the user that it is transmitting the infrared signal, so as to facilitate the user to acknowledge a situation of transmitting codes.

In a further embodiment, after the step S300, it further includes: S400, the electrical appliance feeds the WIFI connection status between the electrical appliance and the router back to the terminal; which includes specifically:

S401, the electrical appliance converts the WIFI connection state between the electrical appliance and the router into the infrared instruction before transmitting to the terminal.

The second WIFI module of the electrical appliance obtains the WIFI connection state before transmitting to the infrared encoding and decoding device, and a successful connection is “good”, while an unsuccessful connection is “bad”; if the connection fails, it may further tell a reason of the connection failure, is it caused by the router having no response or caused by a connection timeout. The infrared encoding and decoding device converts the connection state into an infrared instruction code value, which has a same conversion method as the infrared encoding method of the terminal, that is, first converts each character in the connection state (good or bad No response or bad connection timeout) into an ASCII code value, then converts the ASCII code value into a binary number accordingly, and obtains a data code composed by 0 and 1, followed by adding a head code, a user code and an end code into the data code, before obtaining the infrared instruction code value. The user code herein is a fixed value, such as 00000000 (00) 00000000 (00), which represents the specific infrared instruction code value is transmitting a state information. After superimposing the infrared instruction code value and the carrier signal, the infrared instruction signal will be obtained before being transmitted to the terminal.

S402, the terminal receives and parses the infrared instruction code value, before displaying the parsed connection state.

In such a way, it facilitates the user to acknowledge if the electrical appliance has successfully connected to the router or not, and inquiry a reason of the connection failure.

Based on the above described embodiments, the present invention further provides a WIFI networking system via infrared transmission, shown as FIG. 8, the WIFI networking system comprises a terminal 100 and an electrical appliance 200;
the terminal 100 acquires a networking information about the router and converts same into the infrared signal and transmits the infrared signal to the electrical appliance 200, in a WIFI networking mode; the electrical appliance 200 parses the infrared signal to obtain the networking information, and initiates a connection request to the router according to the networking information; and the electrical appliance 200 establishes a WIFI connection to the router in response to the connection information about the router.

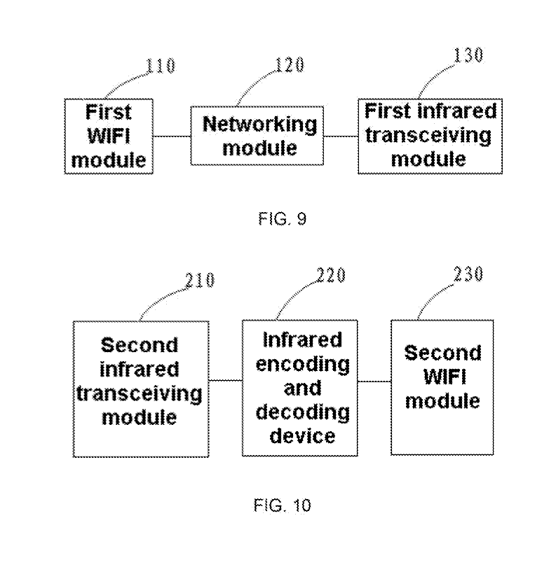

Referencing to FIG. 9 together, the terminal 100 comprises:
a first WIFI module 110, applied to searching automatically for and obtaining the wireless information about the router, before establishing the WIFI connection with the router according to the input WIFI password of the router, when connecting to the router;
a networking module 120, applied to entering the WIFI networking mode, obtaining the networking information about the router, the networking information comprises the WIFI account ID and the password about the router; and generating the infrared code value through infrared encoding the WIFI account ID and the password;
a first infrared transceiving module 130, applied to superimposing the infrared code value and the carrier signal and generating an infrared signal before transmitting to the electrical appliance.

Referencing to FIG. 10 together, the electrical appliance 200 includes:
a second infrared transceiving module 210, applied to receiving the infrared signal and transmitting the same;
an infrared encoding and decoding device 220, applied to parsing the infrared signal, identifying the instruction type of the user code; and outputting the infrared code value after being decoded, when identifying the user code to be an instruction of transmitting the networking information;
a second WIFI module 230, applied to extracting the WIFI account ID and the password from the infrared code value; and initiating a connection request to the router according to the WIFI account ID and the password obtained.

Further, the electrical appliance is applied to feeding the WIFI connection status between the electrical appliance and the router back to the terminal, specifically: the second WIFI module 230 obtains the WIFI connection state and transmits to the infrared encoding and decoding device 220. The infrared encoding and decoding device 220 converts the WIFI connection state into the infrared instruction, and superimposing the infrared instruction code value and the carrier signal through the second infrared transceiving module 210, before achieving the infrared instruction signal and transmitting to the terminal. The first infrared transceiving module 130 receives the infrared instruction code value and transmits to the networking module 120 for parsing, the networking module 120 displays the parsed connection state onto a screen.

All above, the present invention provides a WIFI networking method and system via infrared transmission, adopting a mature infrared transmission method, the WIFI account ID and the password about the router are converted into the infrared signal by the terminal before transmitting to the electrical appliance; the electrical appliance actively connects to the router according to the parsed WIFI account ID and the password. Without subjecting a disturbance from any other WIFI signals in the circumstance, it ensures a connection success rate; sine the second WIFI module of the electrical appliance does not need to keep monitoring, it reduces a power consumption and a connection time cost, it also accelerates a speed of connecting to the network, thus it has effectively solved the problem of having a large interference and a large power consumption when an existing WIFI module is connecting to a network.

It should be understood that, the application of the present invention is not limited to the above examples listed. Ordinary technical personnel in this field can improve or change the applications according to the above descriptions, all of these improvements and transforms should belong to the scope of protection in the appended claims of the present invention.

What is claimed is:

1. A WIFI networking method via infrared transmission, wherein, it comprises:
in a WIFI networking mode, a terminal acquires a networking information about a router and converts same into an infrared signal and transmits the infrared signal to an electrical appliance;
the electrical appliance receives and parses the infrared signal to obtain the networking information, and initiates a connection request to the router according to the networking information; and
the electrical appliance establishes a WIFI connection to the router in response to the connection information about the router.

2. The WIFI networking method via infrared transmission according to claim 1, wherein, before a step of the terminal acquiring the networking information about the router and converting same into the infrared signal and transmitting the infrared signal to the electrical appliance, it further includes:
the terminal pre-installs a networking software;
when connecting to the router, the terminal searches automatically for and obtains wireless information about the router, before establishing a WIFI connection with the router according to an input WIFI password about the router;
the terminal enters a WIFI networking mode after the networking software being started.

3. The WIFI networking method via infrared transmission according to claim 1, wherein, after a step of the electrical appliance establishing a WIFI connection to the router in response to the connection information about the router, it further includes:
the electrical appliance feeds a WIFI connection state between the electrical appliance and the router back to the terminal.

4. A WIFI networking method via infrared transmission, wherein, it comprises a plurality of steps:
in a WIFI networking mode, a terminal acquires a networking information about a router and converts same into an infrared signal and transmits the infrared signal to an electrical appliance;
the electrical appliance receives and parses the infrared signal to obtain the networking information, and initiates a connection request to the router according to the networking information;
the electrical appliance establishes a WIFI connection to the router in response to the connection information about the router;
the step of the terminal acquiring networking information about the router and converting same into the infrared signal and transmitting the infrared signal to the electrical appliance in the WIFI networking mode, includes specifically:
the terminal acquires the networking information about the router in the WIFI networking mode, the networking information comprises a WIFI account ID and a password about the router;
generates an infrared code value through infrared encoding the WIFI account ID and the password;
superimposes the infrared code value and a carrier signal and generates an infrared signal before transmitting to the electrical appliance.

5. The WIFI networking method via infrared transmission according to claim 4, wherein, the step of generating the infrared code value through infrared encoding the WIFI account ID and the password includes specifically:
converting each character in the WIFI account ID and the password into an ASCII code value;
converting the ASCII code value into a binary number accordingly, and obtaining a data code composed by 0 and 1;
adding a head code, a user code and an end code into the data code, before obtaining the infrared code value.

6. The WIFI networking method via infrared transmission according to claim 5, wherein, the step of the electrical appliance receiving and parsing the infrared signal to obtain the networking information, and initiating the connection request to the router according to the networking information includes specifically:
the electrical appliance receives the infrared signal before parsing the same, identifies an instruction type of the user code;
extracts the WIFI account ID and the password from the data code, when identifying the user code to be an instruction of transmitting the networking information;
initiates a connection request to the router according to the WIFI account ID and the password obtained.

7. The WIFI networking method via infrared transmission according to claim 4, wherein, before the step of the terminal acquiring the networking information about the router and converting same into the infrared signal and transmitting the infrared signal to the electrical appliance, it further includes:
the terminal pre-installs a networking software;
when connecting to the router, the terminal searches automatically for and obtains wireless information about the router, before establishing a WIFI connection with the router according to an input WIFI password about the router;
the terminal enters a WIFI networking mode after the networking software being started.

8. The WIFI networking method via infrared transmission according to claim 4, wherein, after the step of the electrical appliance establishing the WIFI connection to the router in response to the connection information about the router, it further includes:
the electrical appliance feeds the WIFI connection status between the electrical appliance and the router back to the terminal.

9. The WIFI networking method via infrared transmission according to claim 5, wherein, before the step of the terminal acquiring the networking information about the router and converting same into the infrared signal and transmitting the infrared signal to the electrical appliance, it further includes:
the terminal pre-installs networking software;
when connecting to the router, the terminal searches automatically for and obtains wireless information about the router, before establishing a WIFI connection with the router according to an input WIFI password about the router;
the terminal enters a WIFI networking mode after the networking software being started.

10. The WIFI networking method via infrared transmission according to claim 5, wherein, after the step of the electrical appliance establishing the WIFI connection to the router in response to the connection information about the router, it further includes:
the electrical appliance feeds a WIFI connection state between the electrical appliance and the router back to the terminal.

11. The WIFI networking method via infrared transmission according to claim 6, wherein, before the step of the terminal acquiring a networking information about the router and converting same into the infrared signal and transmitting the infrared signal to the electrical appliance, it further includes:
the terminal pre-installs networking software;
when connecting to the router, the terminal searches automatically for and obtains wireless information about the router, before establishing a WIFI connection with the router according to an input WIFI password about the router;
the terminal enters a WIFI networking mode after the networking software being started.

12. A WIFI networking system via infrared transmission, wherein, it includes the terminal and the electrical appliance;
the terminal acquires a networking information about a router and converts same into an infrared signal and transmits the infrared signal to the electrical appliance, in a WIFI networking mode; the electrical appliance parses the infrared signal to obtain the networking information, and initiates a connection request to the router according to the networking information; and the electrical appliance establishes a WIFI connection to the router in response to the connection information about the router.

13. The WIFI networking system via infrared transmission according to claim 12, wherein, the terminal comprises:
a first WIFI module, applied to searching automatically for and obtaining the wireless information about the router, before establishing the WIFI connection with the router according to the input WIFI password about the router when connecting to the router;
a networking module, applied to entering the WIFI networking mode, obtaining the networking information about the router, the networking information comprises the WIFI account ID and the password about the router; and
generating the infrared code value through infrared encoding the WIFI account ID and the password;
a first infrared transceiving module, applied to superimposing the infrared code value and the carrier signal and generating an infrared signal before transmitting to the electrical appliance.

14. The WIFI networking system via infrared transmission according to claim 12, wherein, the electrical appliance comprises:
a second infrared transceiving module, applied to receiving the infrared signal and transmitting the same;
an infrared encoding and decoding device, applied to parsing the infrared signal, identifying the instruction type of the user code; and outputting the infrared code value after being decoded, when identifying the user code to be an instruction of transmitting the networking information;
a second WIFI module, applied to extracting the WIFI account ID and the password from the infrared code value; and initiating a connection request to the router according to the WIFI account ID and the password obtained.

15. The WIFI networking system via infrared transmission according to claim 12, wherein, the electrical appliance is further applied to feeding the WIFI connection status between the electrical appliance and the router back to the terminal.
